(19) United States
(12) Patent Application Publication
(10) Pub. No.: US 2003/0098801 A1
(43) Pub. Date: May 29, 2003

(54) E. V. E. emergency vehicle environment

(76) Inventor: Curtis Jude Martin, Kent, OH (US)

Correspondence Address: Curtis Jude Martin, 1675 East Main Street, Kent, OH, 44240-5818, US

(21) Appl. No.: 10/002,569

(22) Filed: Nov. 23, 2001

(51) Int. Cl. G08G 1/00

(52) U.S. Cl. 340/902

(57) ABSTRACT

A system of dedicated channel FM devices for unobstructing the path of emergency vehicles resulting in increased response times and safety. The devices include a small radio receiver in a passenger vehicle and/or in a traffic light fixture that actuates an intermittent warning light when it receives an appropriate signal from a transmitter in an emergency vehicle. The small radio transmitter on or in the emergency vehicle is automatically actuated by the use of the siren in the emergency vehicle.

### BACKGROUND OF THE INVENTION

The present invention relates to a radio transmitter receiver system, and more particularly to an emergency radio transmitter receiver system which creates an Emergency Vehicle Environment (EVE) for unobstructing the path of emergency vehicles resulting in increased response times and safety.

The current system for clearing the path of emergency vehicles is the combined use of sirens and flashers. The sirens are not heard until the emergency vehicle is very close, if at all; The flashers are not seen by drivers going the same direction until rear view mirrors are checked, if at all. The present invention transduces the emergency vehicle's siren to a strobe light already in all of the drivers' lines of sight.

The problems with the said current system are illustrated with an aerial view in FIG. 1. (All non-emergency vehicles are collectively called cars even though this group includes trucks, buses, RVs, etc.) The emergency vehicle 1 has relatively clearer passage on the more dangerous, opposite side of the road since the oncoming cars 2 can see the flashers. The cars 3 in the same lane and closer have no direct visual warning and are slower to pull over, due to having to hear the siren and then see the flashers in rear view mirrors. The cars 4 are stopped at the intersection's red traffic light 6 and are obstructing the path usurping time. The cars 5 are the most dangerous since they are entering the intersection with a green traffic light 6 and are not aware of the sirens and flashers.

### SUMMARY OF THE INVENTION

The solution that EVE affords is illustrated with an aerial view in FIG. 2. The emergency vehicle 7 has clear passage on either side of the road since all cars have visual confirmation of an emergency vehicle's approach from their miniature mobile blinking receivers in their car's interiors and/or the immobile traffic light's blinking blue receiver 11. None of the cars has to rely on direct sensory perception of the emergency vehicle's sirens and flashers. The cars 8 that were stopped at the intersection's red traffic light are now pulled over. The cars 9 previously the most dangerous are now the least dangerous. Cars 10 that need not be inconvenienced, are not.

Accordingly, it is an object of the present invention to provide an emergency transmitter which is relatively inexpensive to manufacture, durable in structure, requires no maintenance if the vehicle's power supply is used, requires little maintenance if the vehicle's power supply is not used, quick and easy to install, efficient in operation and operates automatically if/when desired.

Another object of the present invention is to provide car receivers that are extremely inexpensive to manufacture, durable in structure, requires no maintenance, extremely quick and easy to install, efficient in operation and operates automatically.

Another object of the present invention is to provide blue traffic light receivers that are inexpensive to adapt to unused existing traffic lights, relatively inexpensive to add to newly manufactured traffic lights, durable in structure, require little maintenance, efficient in operation and operate automatically.

Another object of the present invention is to provide an EVE that can increase response times for ambulances to victims and then to hospitals.

Another object of the present invention is to provide an EVE that can increase response times for fire trucks to victims and reduce property damage.

Another object of the present invention is to provide an EVE that can increase response times to crime victims and reduce property loss.

Another object of the present invention is to provide an EVE that can increase safety at dangerous school bus stops using a smaller transmission range.

Another object of the present invention is to provide an EVE that can reduce emergency vehicle caused accidents, injuries and fatalities.

Another object of the present invention is to provide an EVE that can reduce accidents in high-speed pursuits (the only car moving would be the suspect).

Another object of the present invention is to provide an EVE that can reduce railroad crossing train and car/pedestrian collisions, especially where crossing gates are not erected.

Another object of the present invention is to provide an EVE that can enable unmarked law enforcement, secret service and funeral processions clear passage.

Another object of the present invention is to provide an EVE that can enable an immobilized area from a police helicopter for SWAT, National Guard, etc.

Another object of the present invention is to provide an EVE that can enable helicopter ambulances to clear a landing area.

Another object of the present invention is to provide an EVE that can enable airport air traffic control to clear freeways for emergency landings.

Another object of the present invention is to provide an EVE that can enable citywide car immobilization from a local radio station such as for the touch down of a tornado.

Another object of the present invention is to provide an EVE which can enable the deaf, hard of hearing and drivers with windows up, air-conditioning on high with radios on, to safely pull over their cars.

The current system for clearing the path of emergency vehicles with the use of sirens and flashers is inferior to the current system with the addition of the present invention. Other objects, features and advantages of the present invention will become apparent from the following description when taken in conjunction with the accompanying drawings.

### BRIEF DESCRIPTION OF THE DRAWINGS

FIG. 1 is an illustrated aerial view of the relative ineffectiveness of an emergency vehicle's ability to warn passenger vehicles of its approach;

FIG. 2 is an illustrated aerial view of the effectiveness of an emergency vehicle's ability to warn passenger vehicles of its approach employing EVE;

FIG. 3 is an applied and illustrated view of EVE consisting of the emergency vehicle's external or internal transmitter communicating with the passenger vehicle's mounted mobile receiver and the immobile blinking blue traffic light receiver;

FIG. 4 is an illustration and a block diagram of the major components of the transmitter according to the present invention;

FIG. 5 is an enlarged, perspective view of the transmitter according to the present invention;

FIG. 6 is an applied view with an illustration and a block diagram of the major components of the mounted mobile receiver according to the present invention;

FIG. 7 is an enlarged, perspective view of the mobile receiver according to the present invention;

FIG. 8 is an illustration with a block diagram of the major components of the factory installed mobile receiver according to the present invention; and

FIG. 9 is an illustration of immobile receiver housings according to the present invention.

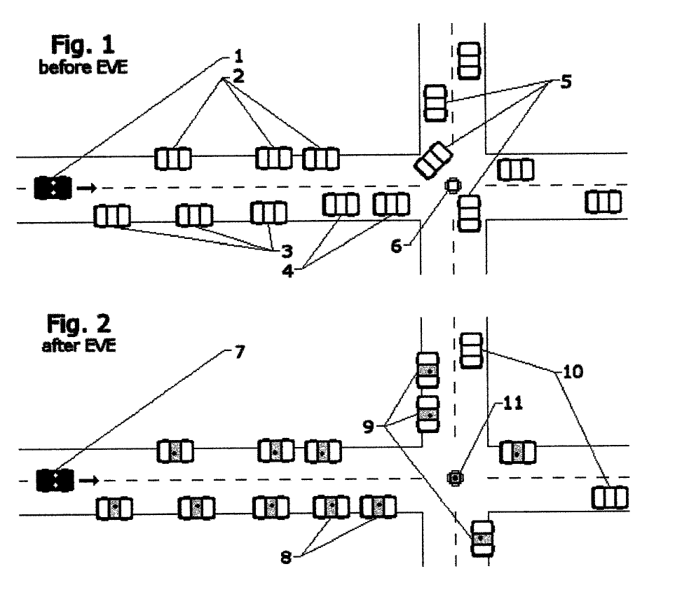

### DETAILED DESCRIPTION OF THE PREFERRED EMBODIMENT

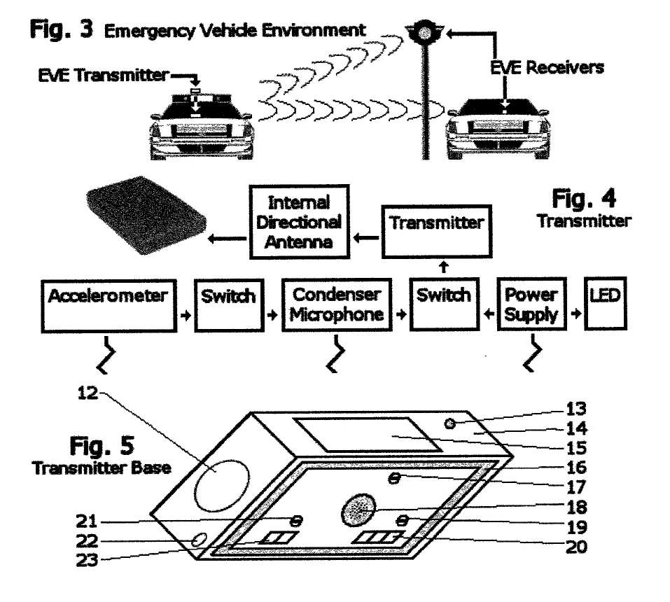

Referring to FIG. 3, an Emergency Vehicle Environment (EVE) is created with the use of three devices named a transmitter, a mobile receiver and an immobile receiver. The transmitter is adhered externally to the emergency vehicle in proximity to the vehicle's siren, whistle, etc, or internally on the dashboard. The mobile receiver is adhered to the dashboard or windshield on the passenger car. The immobile receiver is installed inside the 4-way blue traffic light. When the emergency vehicle actuates its siren the transmitter automatically transmits a signal on a preset carrier frequency already designated for emergency communications with a factory preset signal range that does not carry any appreciable distance beyond the requirements of the emergency vehicle's necessitation. The accelerometer increases the signal's range the faster the emergency vehicle is moving and decreases the signal range the slower the emergency vehicle is moving. The mobile receiver then receives the signal and actuates its strobe light that the driver of the car then unmistakably sees on the dashboard, windshield or instrument panel. The immobile receiver situated at historically dangerous intersections, crowded venues, etc., also receives the signal and actuates its blinking blue traffic light for drivers that do not yet have mobile receivers, inoperative mobile receivers, pedestrian railroad crossings, etc. The drivers then proceed to safely pull their cars over and out of the way of the emergency vehicle.

Referring to FIG. 4, this will be understood by those skilled in the art that the transmitter's printed circuit board of the transmitter is of conventional construction and is divulged in prior art. With the transmitter mounted externally, the on-auto-off switch is switched to the auto position only. The emergency vehicle's siren is then actuated by the emergency vehicle's operator, as it normally would be. The siren actuates the condenser microphone. The condenser microphone actuates the transmitter. The accelerometer adjusts the signals range. The transmitter transmits the signal via the internal directional antenna. The LED is for indicating a low battery power supply.

Referring to FIG. 5, the on-auto-off switch 20 is switched to the auto position when the transmitter is adhered with a peel and stick perimeter 16 externally to the emergency vehicle enabling the transmitter to automatically actuate when the siren is actuated. The condenser microphone 18 is actuated by the actuation of the siren, unless it is overridden by hardwiring from the vehicle's siren switch at input port 19. The condenser microphone 18 then actuates the transmitter mounted within the upper cover shell 14. The transmitter transmits the signal forward via the internal directional antenna 12. The accelerometer 22 automatically adjusts the signal's range when the on/off switch 23 is on. The accelerometer extension port is 21. The LED 13 is for indicating a low power supply. The battery lid cover 15 on the battery chamber is for accessing batteries. The external power supply input port 17 is for connecting a power cord to the vehicle's power supply, overriding the batteries as a power source.

Mounting the transmitter wholly externally affords extremely quick and easy installation, but requires battery replacements 15. Mounting the transmitter internally, eliminates battery maintenance and enables manual operation of the on-auto-off switch 20, but requires installation. Another option is to mount the transmitter externally with the power cord connecting the external power supply input port 17, to the vehicle's power supply via the power feeding the flashers and/or siren. The best mode is internally.

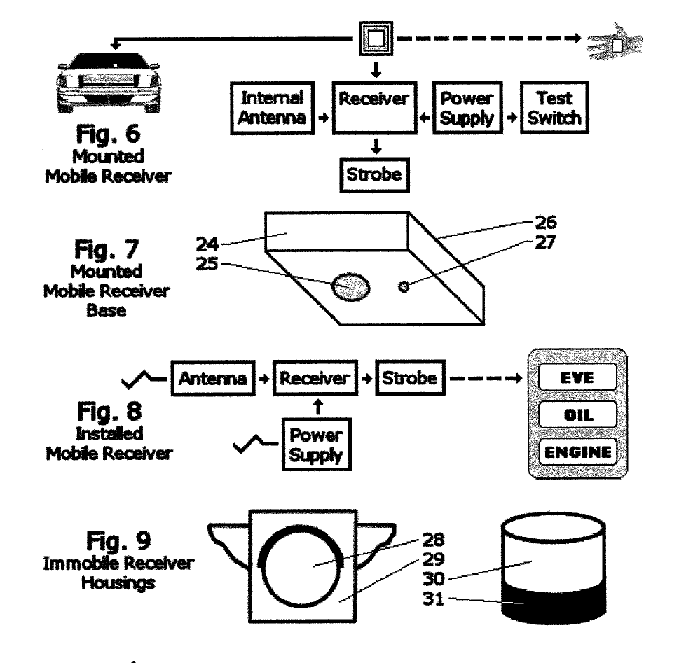

Referring to FIG. 6, this will be understood by those skilled in the art that the receiver's printed circuit board is of conventional construction and is divulged in prior art. With the mobile receiver, the internal omni-directional antenna receives the transmitter's signal that actuates the receiver. The receiver actuates the strobe light that alerts the car's driver to pull over. When the test switch button is depressed, if the strobe light does not actuate the battery is low or the unit needs replacing.

Referring to FIG. 7, the mounted mobile receiver 24 is adhered with a peel and stick rectangular pad 26 (backside) to the passenger car's dashboard or windshield. Upon receipt of the transmitter's dedicated signal the strobe light 25 is actuated. The test switch button 27 is to make sure the unit is functioning properly.

Referring to FIG. 8, the installed mobile receiver is the mounted mobile receiver installed at the factory as original equipment and is hidden within the dashboard. The bottom cover plate, antennas, test switch and battery terminal connectors are omitted. An antenna cable conjoins the car's radio antenna. The receiver's power supply conjoins the car radio power supply. The strobe light is mounted in the vehicle's instrument panel with wire cable extending to the receiver. The best mode is factory installed.

Referring to FIG. 9, the immobile receivers' housings can take the form of conventional traffic lights 29 and have blinking blue lights 28 or use the round beacon form 31 and have rotating blue lights or blue strobe lights 30. The immobile receivers in either housing can be added to a red-yellow-green traffic light, blinking red/yellow, 4-way, 2-way, stand-alone, post, pole, etc. It is to be understood that the drawings are designed for purpose of illustration only, and are not intended as a definition of the limits and scope of the invention disclosed.

What the invention disclosed is:

1. a broadcasting system using frequency modulation to create an Emergency Vehicle Environment (EVE) for unobstructing the path of emergency vehicles.

2. a small radio transmitter—externally and internally adaptable—comprising:
the external transmitter comprising of a unibody upper and sides cover shell and a bottom cover plate fastened together, a peel and stick perimeter acting as a gasket between said bottom cover plate and vehicle, a transmitter printed circuit board mounted within said upper cover shell, the said transmitter printed circuit board is fixed to one channel, the transmitting frequency of the said transmitter being set within 35 MHz to 2.5 GHz for FM stereo or mono audio radio signal transmission, a directional antenna mounted internally in said upper cover shell and connected to said transmitter printed circuit board for transmitting the radio signal, a battery chamber disposed at a side of said upper and sides cover shell, battery terminal connectors mounted inside said battery chamber at two opposite ends and respectively connected to said transmitter printed circuit board, a battery lid cover on said battery chamber, a low battery indicator LED mounted to the side of said battery chamber on said upper and sides cover shell and connected to said transmitter printed circuit board, an external power supply input port mounted to said bottom cover plate and connected to said battery terminal connectors, a condenser microphone mounted to the said bottom cover plate and connected to said transmitter printed circuit board, an external input port for overriding said condenser microphone mounted to said bottom cover plate and connected to said transmitter printed circuit board, an accelerometer mounted to the said bottom cover plate and connected to said condenser microphone, an external input port for extending said accelerometer mounted to said bottom cover plate and connected to said condenser microphone, an auto/on/off switch for engaging or disengaging said condenser microphone and for engaging or disengaging said power supply, an on/off switch for engaging or disengaging said accelerometer
the internal transmitter is the external transmitter mounted on the dashboard with the said peel and stick perimeter gasket being replaced with a peel and stick rectangular pad placed on the opposite side—the said cover shell

3. a small radio receiver—mounted in existing/aftermarket vehicles, installed as original equipment in new vehicles and installed in unused existing or new traffic light fixtures—comprising:
the mounted mobile receiver adapted to receive the radio signal transmitted from said transmitter, said receiver comprising of a unibody upper and sides cover shell and a bottom cover plate fastened together, a peel and stick rectangular pad for affixing said upper and sides cover shell to a dashboard or windshield, a receiver printed circuit board mounted within said upper cover shell, the said receiver printed circuit board is fixed to one channel, an internal omni-directional receiving antenna wire mounted around the inside of said upper and sides cover shell and connected to said receiver printed circuit board for receiving the radio signal, battery terminal connectors mounted within said upper cover shell and connected to said receiver printed circuit board, the system using a 1.5V-3V battery to provide the necessary working voltage, a push to test switch button mounted to said bottom cover plate and connected to said receiver printed circuit board, a strobe light mounted to said bottom cover plate and connected to said receiver printed circuit board
the installed mobile receiver is the receiver installed at the vehicle's factory as original equipment and is mounted within the dashboard, said bottom cover plate is omitted, said antenna is omitted, an antenna cable conjoins the vehicle's radio antenna, said push to test switch button is omitted, said battery terminal connectors are omitted, said receiver's power supply conjoins the vehicle's radio power supply, said strobe is mounted in the vehicle's instrument panel with wire cable extending to said receiver
the installed immobile receiver in unused existing or new traffic light fixtures is mounted within the traffic light fixture, said bottom cover plate is omitted, said antenna is replaced with an external flush-mounted antenna, said push to test switch button is omitted, said battery terminal connectors are replaced with a transformer that connects to power line, the strobe's bulb is replaced with the standard traffic light's bulb, the colored glass lens of the traffic light is blue—the traffic light blinks blue similarly to a blinking red traffic light
